(19) United States
(12) Patent Application Publication
(10) Pub. No.: US 2026/0311419 A1
(43) Pub. Date: Oct. 8, 2026

(54) Scene Inversion to Preserve Visible Precision in Large-Scale Three-Dimensional Floating-Point Graphics Rendering

(71) Applicant: Metaversal Corporation, Dover, DE (US)

(72) Inventor: Dean Abramson, Westlake Village, CA (US)

(73) Assignee: Metaversal Corporation, Dover, DE (US)

(21) Appl. No.: 19/577,229

(22) Filed: Mar. 24, 2026

Related U.S. Application Data
(60) Provisional application No. 63/777,655, filed on Mar. 25, 2025.

(51) Int. Cl. G06T 15/20; G06T 1/60

(52) U.S. Cl. CPC G06T 15/20; G06T 1/60

(57) ABSTRACT

A computer-implemented method depicting a three-dimensional scene maintains a scene graph comprising nodes in a hierarchical parent-child relationship, with one root node at a world origin and each other node having a local transform relative to its parent. A scene inversion is performed along a path from a target node through each successive ancestor to the root node, such that the target becomes the root node, while preserving the relative physical arrangement of nodes in three-dimensional space. The scene inversion reduces magnitudes of world transforms near the target node, improving floating-point precision for large-scale three-dimensional scenes. In some aspects, a virtual anchor node is inserted into the scene graph and selected as the target node.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### CROSS-REFERENCE TO RELATED APPLICATIONS

This application claims the benefit of U.S. Provisional Patent Application No. 63/777,655, filed Mar. 25, 2025, and entitled “Method for Large Scene Inversion for Preserving Visible Precision in Floating-Point Graphic Engine Rendering,” the entire contents of which are hereby incorporated herein by reference for all purposes.

### FIELD OF THE INVENTION

This invention relates to coordinate management and rendering techniques in three-dimensional (3D) applications that display 3D graphics, and more particularly to scene inversion to preserve visible precision in large-scale 3D floating-point graphics rendering in such applications.

### BACKGROUND

Interactive 3D applications such as video games, simulations, and virtual reality systems create the perception of three-dimensionality by rendering images of objects from a viewer's perspective. To do so, these applications maintain a mathematical representation of each object's location and orientation in 3D space. Each object—such as an avatar, vehicle, building, or planet—has a transform that is tracked and updated as the application runs. These concepts apply to both single-user and multi-user environments, including massively multiplayer online games and shared simulation augmented and virtual worlds.

Most such applications organize objects into a hierarchical tree data structure commonly referred to as a scene graph or transform hierarchy. In such hierarchies, each object possesses a local transform that is defined relative to its parent. A root node corresponds to a world origin, which acts as an origin, or reference point for the entire scene. To obtain an object's world-space transform, the application composes the object's local transform with the transforms of its ancestors up to the root. The resulting world-space transforms are consumed by the graphics pipeline for rendering and by subsystems such as physics and artificial intelligence (AI) for simulation and gameplay logic.

Graphics processing units (GPUs) and application programming interfaces (APIs) for graphics standards such as OpenGL, Direct3D, and Vulkan typically operate with IEEE-754 single-precision (32-bit) and occasionally double-precision (64-bit) floating-point values for vertex positions and transformation matrices in the rasterization pipeline. Single-precision values allocate 23 bits for the significand, which guarantees only seven decimal digits of precision. A fundamental property of this representation is that the spacing between representable values (the unit in the last place, or ULP) grows in proportion to the magnitude of the value. As the absolute value of a coordinate increases, the smallest distinguishable difference between nearby coordinates increases. Small offsets that are easily represented near the origin become indistinguishable at large distances from the origin.

This behavior is generally acceptable when world-space coordinates remain within a relatively modest range from the world origin, for example, within about 10\hat{ }4 meters (10 kilometers). In typical indoor environments or small outdoor areas, object positions fall in this range, and single-precision arithmetic provides millimeter-scale resolution or better. This level of precision is sufficient for smooth animation, stable collision detection, and accurate camera control.

Many modern applications, however, employ large-scale environments whose extents are several or many orders of magnitude larger. Representative domains include planetary-scale and solar-system-scale games and simulations, open-world titles that allow traversal over hundreds or thousands of kilometers, and space exploration experiences spanning interplanetary or interstellar distances. In such environments, celestial bodies or large terrain features may be represented with world-space coordinates on the order of 10\hat{ }24 meters (10\hat{ }21 kilometers) from a world origin. At these magnitudes, the ULP of a 32-bit floating-point value can be on the order of 10\hat{ }18 meters. At this scale, differences of one billion kilometers between two distinct positions are not representable at all.

Precision loss at these scales affects a wide range of coordinate-dependent operations within a 3D application. For example, hierarchical transform composition may fail to apply small local offsets when they are added to large parent translations. Frame-to-frame motion and animation integration may produce no visible movement for many frames and then sudden jumps when accumulated deltas exceed a coarse representable step. Physics and collision detection may suffer from numerical cancellation when subtracting large, nearly equal world-space positions to obtain small relative distances, leading to missed contacts or unstable constraints. Ray casting and intersection tests may compute inaccurate or inconsistent intersections when ray parameters and geometry are expressed with large coordinates. Culling, level-of-detail (LOD) selection, navigation queries, and AI behaviors that rely on distances, region membership, or spatial hashing can likewise become unreliable when nearby objects are quantized to the same coarse coordinate.

### SUMMARY

The present invention provides computer-implemented methods to preserve visible precision in large-scale three-dimensional scene rendering through scene inversion.

In some aspects, the invention is directed to preserve visible precision in large-scale three-dimensional scenes by restructuring a scene graph so that a selected target node becomes the root node through inversion of the parent-child relationships along the path from that node to the original root node, with inverse transforms substituted so the physical spatial arrangement is preserved while nearby objects are expressed in smaller world-space coordinates that are more precisely representable in single-precision or double-precision floating point.

In one general aspect, a computer-implemented method maintains, in memory of a computing device, a scene graph having a plurality of nodes organized in a hierarchical tree data structure, where the scene graph has a root node (R) at a world origin, and where each particular node, other than the root node (R), has a singular parent node and zero or more child nodes, and where each particular node has a local transform expressing a configuration of position, rotation, scale, or shear in accordance with a transformation rule of the particular node relative to its parent node, wherein transform values of nodes in the scene graph are represented using floating-point values. The method includes selecting a target node (N) from the plurality of nodes, where the target node (N) is a descendant of the root node (R) in the scene graph. The method furthermore includes identifying a path from the target node (N) to the root node (R) through the scene graph, the path having the target node (N), each successive ancestor of the target node (N), and the root node (R), where the path terminates at the root node (R). The method also includes performing a scene inversion along the path to form an inverted path, where, after the scene inversion, the target node (N) becomes the root node such that inverted local transforms of nodes along the inverted path are expressed relative to their respective inverted parent, formerly a child, and where the relative physical arrangement of nodes in three-dimensional space is preserved. The method also includes rendering one or more objects in the scene graph using the inverted path.

Other embodiments of this aspect include corresponding computer systems, apparatus, and computer programs recorded on one or more computer storage devices, each configured to perform the actions of the methods.

Implementations may include one or more of the following features, alone or in combination:

The method may include inserting a virtual anchor node into the scene graph prior to performing the scene inversion, where the virtual anchor node is inserted at a chosen position in the scene graph, where one or more nodes in the scene graph are reparented as children of the virtual anchor node, and where the virtual anchor node is selected as the target node (N).

The method where the virtual anchor node does not correspond to a visible or interactive object in the scene graph.

The method where the virtual anchor node is positioned at or near a camera viewpoint or a player position in the scene graph.

The method may include removing the virtual anchor node from the scene graph when the virtual anchor node is no longer needed.

The method where the position of the virtual anchor node in the scene graph is snapped to a predetermined interval, such that a plurality of nodes located near one another in the scene graph share the virtual anchor node as a common parent node in the scene graph.

The method may include updating the position of the virtual anchor node in the scene graph as a camera viewpoint or a player position moves through the scene graph and re-performing the scene inversion after updating the position of the virtual anchor node.

The method where the floating-point values comprise single-precision floating-point values.

The method where the floating-point values comprise double-precision floating-point values.

The method where the floating-point values comprise IEEE-compliant or non-IEEE floating-point representations.

The method where, after the scene inversion, at least one descendant node of the target node is represented by a world-space coordinate having a smaller magnitude than before the scene inversion.

The method where the smaller-magnitude world-space coordinate corresponds to a smaller unit in the last place for that coordinate than before the scene inversion.

The method where vertices and coordinate calculations used for rendering are represented using floating-point values.

The method where the scene inversion is performed starting from the root node (R).

Implementations of the described techniques may include hardware, a method or process, or a computer tangible medium.

The relative nature of objects means that any transformation of an object relative to its parent object is equivalent to an equal but opposite (inverse) transformation of the parent object relative to the object. For example, if an object is translated 5 meters in the x direction away from its parent object, it would yield the same visible result if the parent object were translated −5 meters in the x direction away from the object. Similarly, if an object is rotated 30 degrees in a clockwise direction around the z-axis of its parent object, it would yield the same visible result if the parent object were rotated 30 degrees in a counterclockwise direction around the z-axis of the object.

With this method, objects far from the camera viewpoint will still be subject to loss of precision due to the inherent limitations of floating-point numbers, as described earlier. However, the loss of precision is not significant because it occurs at distances far away in the scene. Objects that experience this loss of precision will have no adverse results that will visibly impact the scene.

The method solves the precision problem by reconfiguring the scene such that the origin of the scene is closer to the camera viewpoint and nearby objects.

Implementations of the described techniques may include hardware, a method or process, or a non-transitory computer-readable storage medium.

### BRIEF DESCRIPTION OF THE DRAWINGS

Other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 is a block diagram of an example client computing device.

FIG. 2 shows aspects of a client's view of a 3D scene.

FIGS. 3A and 3B illustrate aspects of the hierarchical relationship between two nodes in a scene graph, before and after inversion.

FIGS. 4A and 4B are flowcharts illustrating aspects of scene inversion in accordance with embodiments hereof.

FIGS. 5A, 5B, and 5C show examples of large scene inversion, in accordance with embodiments hereof.

FIG. 6 depicts aspects of computer and data processing systems used to implement aspects hereof.

### DETAILED DESCRIPTION

In the following, exemplary embodiments of the invention will be described, referring to the figures. These examples are provided to further illustrate the invention without limiting its scope. Alternate embodiments and variations of the subject matter described herein will be apparent to those skilled in the art.

The following detailed description is made with reference to the accompanying drawings, which illustrate example embodiments and are not necessarily to scale. Like reference numerals refer to like elements throughout. Functional blocks can represent circuits, firmware, software, or any combination thereof. The embodiments are illustrative, not limiting, and are not restricted to the particular arrangements shown.

Reference numerals have been referred to for quicker understanding and are not intended to limit the scope of the present invention in any manner.

### Glossary

As used herein, unless indicated otherwise, the following terms or abbreviations have the following meanings:

A “transform” refers to data representing a rigid or affine transformation in three-dimensional space, including a translation (position), rotation (orientation), scale, or shear. A transform may be represented in any suitable format, such as a 4×4 homogeneous transformation matrix, a combination of a translation vector, a quaternion, and a scale, or another equivalent mathematical representation.

A “local transform” of an object refers to the transform that expresses the object's transform relative to its parent node in a scene graph.

A “world-space transform” of an object refers to the transform that expresses the object's transform in a designated world coordinate system, relative to the origin of the scene. The world-space transform can be obtained by composing the object's local transform with all of the local-space transforms (or equivalent representations) of its ancestors in the scene graph.

The “world-space position” of an object refers to its location in the designated world coordinate system and may be represented as a three-dimensional coordinate (x, y, z). In many embodiments, the world-space position corresponds to, or is derived from, the translation component of the object's world-space transform. Unless otherwise specified or clear from context, references to the “position” of an object refer to its world-space position.

A “scene graph” or “transform hierarchy” refers to a data structure that organizes objects in a three-dimensional scene according to hierarchical parent-child relationships, wherein each object's spatial configuration is defined relative to its parent. A scene graph may be implemented as a tree or another hierarchical structure. It may include nodes representing renderable or non-renderable objects, cameras, lights, or other scene elements.

A “world origin” refers to a designated reference point that serves as the origin of a scene's world coordinate system. The world origin, by definition, corresponds to the point in the scene at position (0, 0, 0) and provides a reference relative to which world-space transforms of objects are defined. Unless otherwise specified or clear from context, references to the “origin” of a scene refer to the world origin.

A “virtual anchor” refers to a non-renderable node added to a scene (e.g., inserted into a scene graph) that serves as a parent node for other elements in the scene (e.g., for precision-critical objects). A virtual anchor may be positioned strategically to provide small world-space coordinates for its descendants, thereby improving numerical precision for computations involving those descendants.

A “precision-critical object” refers to an object in a scene for which relatively small differences in position and/or orientation are significant to rendering quality, physics simulation, gameplay, or other computations. Examples of precision-critical objects include, without limitation, objects located near an active camera or viewpoint, objects participating in fine-grained physics interactions (such as collision detection or joint constraints), and objects directly involved in player interactions.

“Scene inversion” refers to an operation on a scene graph or transform hierarchy in which one or more parent-child relationships between nodes are reconfigured so that a node that was previously a descendant becomes an ancestor, while preserving the relative spatial configuration between the affected nodes. Scene inversion preserves relative transforms between nodes on the affected portion of the scene graph for the purpose of changing which node serves as the root node.

“Reparenting” a node refers to changing the parent of that node in a scene graph, for example, by detaching the node from a its parent and attaching the node to a different parent. Reparenting includes adjusting the node's local transform so that the node's world-space transform is preserved across the change in parent.

The term “unit in the last place” or “ULP” at a given value or coordinate magnitude refers to the spacing between adjacent representable floating-point values at that value or magnitude. In the context of a position coordinate, the ULP indicates the smallest change in the coordinate value that can be represented by the floating-point format at that magnitude.

“Visible precision” refers to the positional accuracy required to avoid perceptible artifacts, such as jittering, Z-fighting, or misalignment, in rendering, physics simulation, or gameplay.

As used herein, “mechanism” denotes structure or programmed functionality (or a combination thereof) that performs one or more operations. A mechanism may be implemented by one or more of: (i) hardware circuitry (e.g., analog or digital logic, finite-state machines, ASICs (Application-Specific Integrated Circuits), configurable logic such as FPGAs (Field-Programmable Gate Arrays), microcontrollers); (ii) one or more processors executing stored instructions (applications, libraries, kernels, services); (iii) firmware or microcode executing on controllers or processors; (iv) software processes executing on one or more computers and exposing defined interfaces (e.g., application programming interfaces (APIs)) to provide a network-accessible function. Components of a mechanism can be centralized within a single device or distributed across multiple devices, co-located or remote, and operatively coupled by wired or wireless links. A mechanism may include cooperating sub-mechanisms that together perform the operations and may be composed of other mechanisms. The foregoing implementations are illustrative and non-limiting. The terms “module” and “engine” refer to mechanisms. For example, the inversion mechanism may be referred to as an inversion module or an inversion engine.

The System and Devices on which the Invention Operates

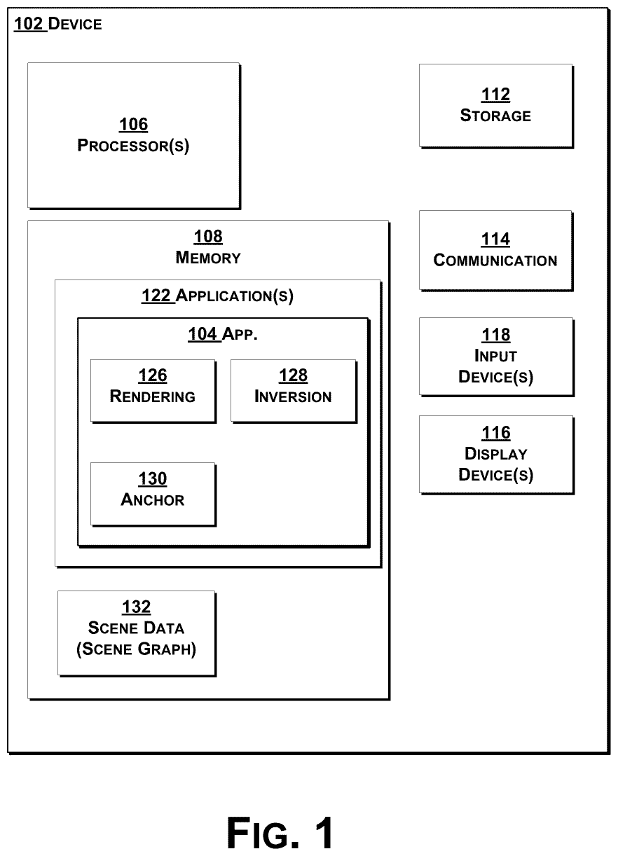

FIG. 1 is a block diagram of an example device 102 configured to execute a 3D application 104 implementing aspects of the system. The device 102 is a computing device as described below (under the heading “Computing”). It includes one or more processors 106 (preferably including a GPU), memory 108, storage 112, one or more display devices 116, and network/communications interfaces 114, input/output interfaces 118 (e.g., keyboard, mouse, game controller, and the like). The device may be a desktop computer, a laptop computer, a game console, a VR headset, or the like. The system is not limited to the type of device.

The memory 108 may store an operating system, a game or simulation engine or other applications 122 (e.g., application 104) that may include various modules, including a rendering module 126, an inversion module 128, and an anchor module 130.

The application 104 may be a mechanism (as defined above) comprising hardware and software. The system is not limited by the type of application or its implementation.

A 3D object may be rendered on a display device 116. The rendered version of the 3D object depends on the device and on the position of that 3D object relative to the client.

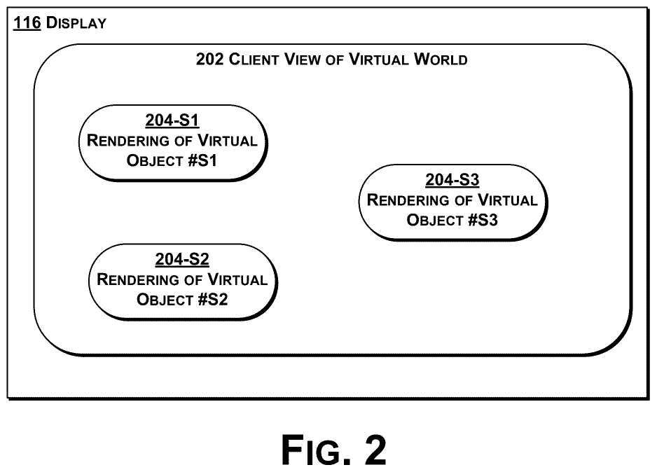

As shown in FIG. 2, the client's view 202 of a virtual world (on one or more display devices 116) may include renderings or representations 204 of some of those objects (e.g., renderings or representations 204-S1, 204-S2, 204-S3 corresponding to 3D objects S1, S2, and S3, respectively).

### Scene Representation

3D scenes in a scene graph are formed by placing objects into the scene relative to a parent object. Any object can be placed underneath a parent object in a scene graph, and as such, is positioned relative to its parent object by a transform, typically consisting of:
a translation: (x, y, z), a vector from the origin of the parent object,
a rotation: (w, x, y, z), a quaternion relative to the orientation frame of the parent object, and
a scale: (x, y, z), applied relative to the parent object,
   but could also be represented by a four-dimensional transform matrix, or any other approach by which transforms can be stored and computed.

The collection of all objects in the scene forms a scene graph from a root object at the origin (0, 0, 0) of the space, on down.

The scene graph 132 may be stored and maintained in memory 108 (e.g., as scene data/hierarchy).

A scene graph uses floating-point numbers to store the transform values of each object. Each node in the scene graph also carries references to its geometry, materials, and other per-object properties. The camera is a node in the scene graph with the same form of transform as any other object; it additionally carries a projection transform that describes how the scene is viewed (e.g., perspective or orthographic).

For rendering, a rendering mechanism 126 traverses the scene graph 132, accumulating the world-space transform of each object by composing local transforms from the root down to each node. The camera node's world transform is inverted to produce a view transform and combined with the camera's projection transform. The resulting transform data, along with vertex geometry, is passed to a processing unit (e.g., a GPU).

The processing unit applies these transforms to the vertices of each object, ultimately producing the rendered image as seen from the camera viewpoint.

### Scene Inversion to Preserve Visible Precision

### Scene Inversion Principle

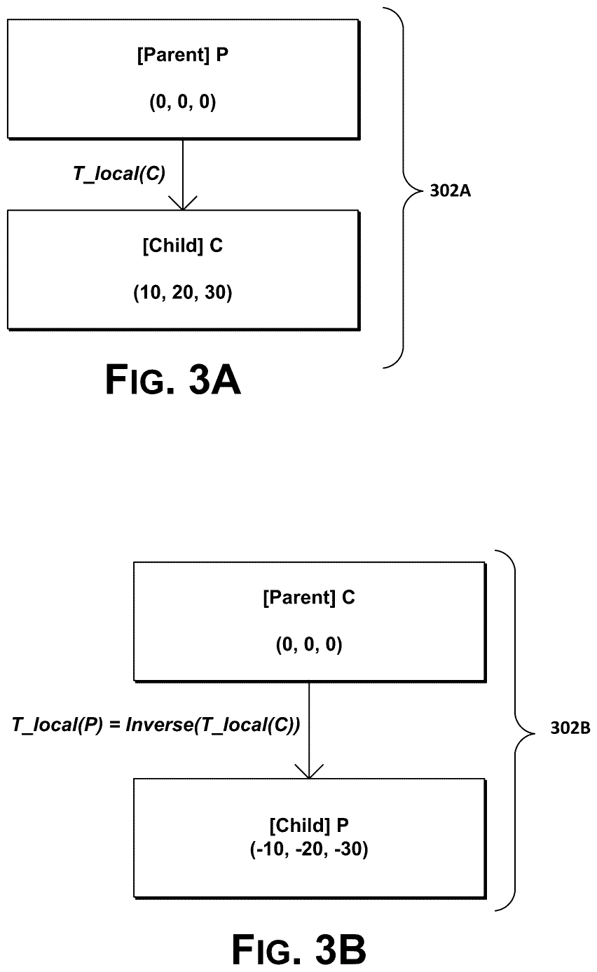

FIG. 3A illustrates aspects of the hierarchical relationship between two nodes in a conventional scene graph according to embodiments hereof.

For two nodes (a parent node P at the origin and a second node C being a child of P) in a scene graph 302A, the spatial relationship between nodes P and C is symmetric and can be inverted. That is, node P's transform can be equivalently expressed relative to node C rather than node C's transform relative to node P, while preserving the physical arrangement of the two nodes in space.

Child node C has a local transform T_local expressing node C's position and orientation relative to node P. The world-space transform of node C is obtained by composing node P's world-space transform with T_local:

$$T\_world ( C ) = T\_world ( P ) ◦ T\_local ( C )$$

where the operator “∘” denotes transform composition.

FIG. 3B illustrates the inverted hierarchical relationship 302B of the nodes in FIG. 3A.

As shown in FIG. 3B, when the parent-child relationship is inverted so that node C becomes the parent at the origin and node P becomes the child, a new local transform T_local (P) is computed as the inverse of T_local (C) such that the world-space transforms of nodes P and C, as elements of a global coordinate frame, represent the same physical transforms as before inversion. In other words, conceptually, change only the location of the origin of the scene while keeping the underlying rigid-body configuration the same.

The significance of this inversion for floating-point precision is that the choice of which node carries small or large world-space coordinates is arbitrary from a geometric standpoint. In a conventional hierarchy where a distant origin serves as the root, objects far from the root have large world-space coordinates and suffer from poor floating-point resolution. By inverting the hierarchy to make one of those distant objects the root, that object and its nearby descendants acquire small world-space coordinates, improving precision for arithmetic operations involving those objects.

### Scene Inversion Operation

Any node in the scene graph can be promoted to serve as the root node by inverting the parent-child relationships along the path from that node to the root node. Objects that are descendants of the promoted node will have world-space coordinates closer to that node compared to the distant original root node, improving precision in the subtree rooted at the promoted node.

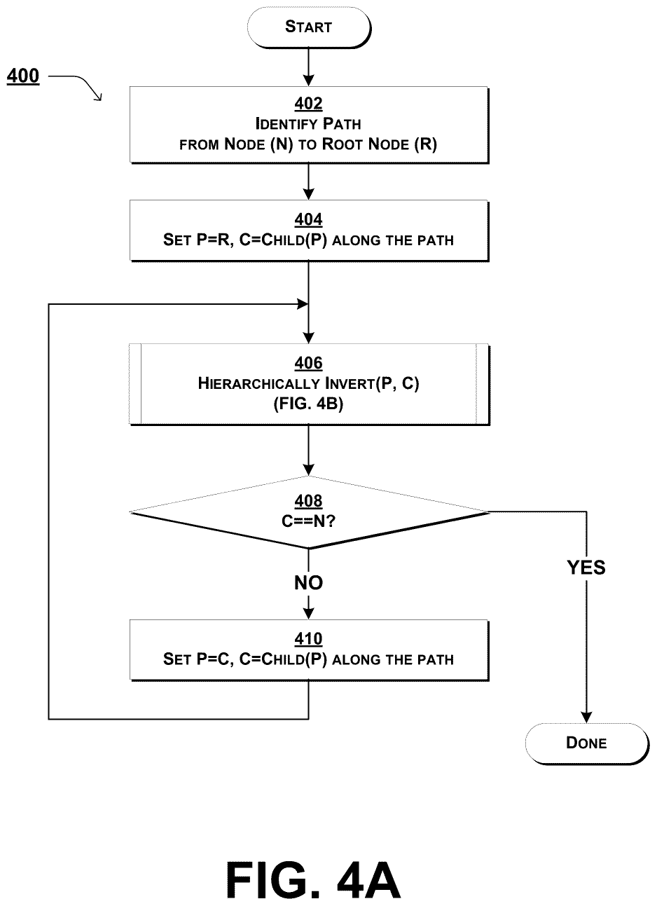

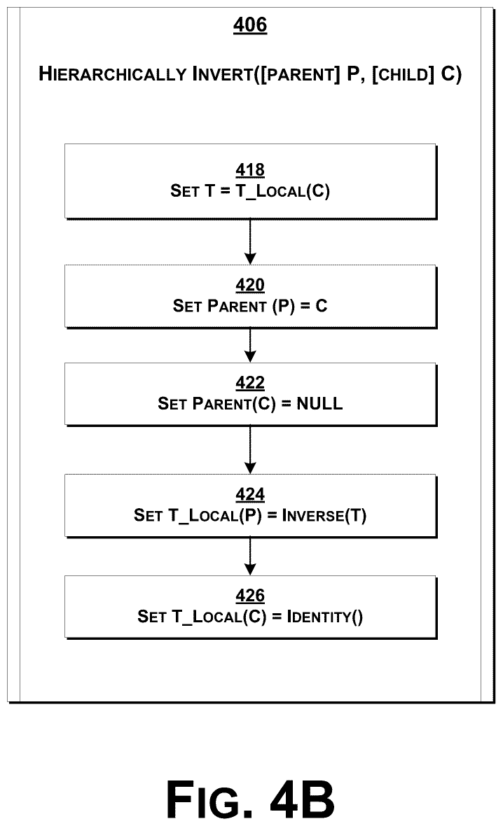

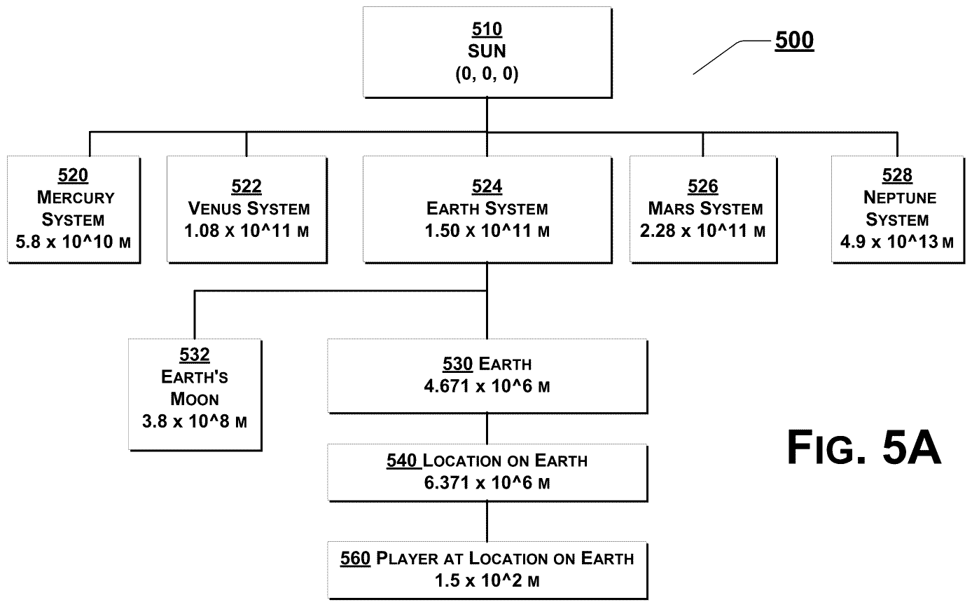

With reference to the flowchart 400 in FIGS. 4A and 4B, to promote a node (N) to the root node, the inversion engine 128 performs the following operations. Identify the path from node (N) to the root node (R) (at 402):

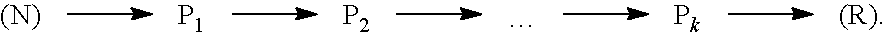

FIG. 4A illustrates an example process for iteratively applying a scene inversion operation along a path from N to R. The process begins at step 402 by identifying the path from N to R. At step 404, the first pair of nodes, P and C, along the path is selected by setting P=R and setting C-Child(P) along the path, the scene inversion operation Hierarchically Invert(P, C) is performed (at 406), as shown in greater detail in FIG. 4B. At step 408, the process tests whether C is equal to N (the last node in the path from the root). If C is equal to N, the process terminates. Otherwise, at step 410, the next pair of nodes along the path is selected by setting P=C and setting C-Child(P) along the path, and the process continues at 406.

FIG. 4B illustrates the scene inversion operation (Hierarchically Invert(P, C)). In the illustrated operation, T is set equal to T_Local(C) (at 418). Parent(P) is set equal to C (at 420). Parent(C) is set to null (at 422). T_Local(P) is set equal to Inverse(T) (at 424). T_Local(C) is set equal to Identity( ) (at 426).

Read together, FIGS. 4A and 4B show the scene inversion operation 406 repeatedly applied to successive (P, C) pairs along the identified path until the comparison at step 408 indicates that C is equal to N.

While scene inversion with respect to a node (N) and a root node (R) has been described as performed iteratively in the direction from the root node (R) to the node (N), it should be understood that inversion may start at node N and be performed iteratively in the direction from node (N) to the root node (R).

This scene inversion operation affects only the nodes along the path from node (N) to the root node (R). Nodes that are siblings of nodes on this path, or descendants of such siblings, are not affected by the inversion and do not require transform updates. This localized operation ensures that the computational cost of inversion is proportional to the depth of the path being inverted, not to the total number of nodes in the scene.

### Virtual Anchor Nodes

In some embodiments, a virtual anchor node is inserted into the scene graph specifically to serve as a precision-preserving reference frame. A virtual anchor has a position and orientation, but typically does not correspond to any visible object. It exists solely to act as a parent node for other objects in the scene, and for the intended purpose of being promoted to become the root node by way of scene inversion in order to provide small world-space coordinates for its descendants. A virtual anchor is typically temporary and is typically deleted when not in use or needed.

### Inserting a Virtual Anchor

To insert a virtual anchor into an existing scene graph, the engine performs the following operations:
1. Create a new virtual anchor node (VA) with a chosen world-space transform, T_anchor.
2. Insert VA into the scene graph as a child of an appropriate parent node that encompasses the space of VA.
3. Compute VA's local transform relative to its parent such that VA's world-space transform equals T_anchor.
4. Identify objects that should be reparented to VA (e.g., objects within a specified radius of T_anchor, or objects tagged as belonging to a particular region).
5. For each object node (O) to be reparented:
   a. Detach O from its current parent.
   b. Attach O as a child of VA.
   c. Recompute O's new local transform relative to VA.

This process ensures that each object node (O)'s world-space transform remains unchanged in world-space while its local transform is now expressed relative to the virtual anchor node (VA).

The process of inverting the scene graph when selecting a virtual anchor as the target node is identical to the inversion process described above for other nodes. The virtual anchor node is promoted to be the root node, and objects requiring precision are made descendants of that anchor.

Compatibility with Existing Systems

The scene inversion techniques described herein are designed to integrate with existing scene graph implementations and rendering pipelines with minimal modification.

Virtual anchors are represented as ordinary scene nodes with the standard properties and methods:
Parent/child relationship management.
Local transform storage.
World transform computation.
Traversal and visitation.

The virtual anchor's special role as a precision-preserving reference frame does not require fundamentally different node types or special-case code in scene graph traversal.

### Choice of Anchor Position

Anchors are preferably placed to benefit precision-critical objects in a scene. In practical applications, certain objects or regions within a scene (e.g., precision-critical objects) may benefit from higher precision than others. Objects involved in detailed rendering, physics simulation, player interaction, or other precision-sensitive operations benefit from having small world-space coordinates. Distant objects that serve primarily as background elements or are viewed from afar can tolerate larger world-space coordinates and corresponding precision loss without visible artifacts.

For example, in a solar system simulation, a player character on Earth's surface is far more precision-critical than distant planets or the Sun. By inverting the scene graph to make a location near the player the root of the scene graph, the player and nearby objects inherit small world-space coordinates and therefore, higher precision. At the same time, the Sun and distant planets inherit large world-space coordinates but suffer negligible visible effects due to their distance from the camera.

### Rendering Pipeline

From the rendering subsystem's perspective, it receives world-space or camera-space transforms for visible objects and issues draw calls as usual. The fact that these transforms were computed using an inverted scene graph is an implementation detail of the transform system.

In camera-relative rendering embodiments, the renderer receives camera-space transforms directly and handles them the same way regardless of whether those transforms are computed with an original or inverted scene graph.

Thus, example implementations of a method for managing coordinates in a three-dimensional scene are provided.

### EXAMPLES

Non-limiting examples are provided to illustrate the scene inversion process with concrete numbers.

### Worked Example I: Two-Node Inversion

Consider a simple scene with two nodes: a parent node, the Sun, and a child node, Earth.

### Initial Configuration (Before Inversion):

The Sun is the root node with world-space transform:

$$T\_world ( Sun ) = ( 0 , 0 , 0 ) .$$

Earth is a child of the Sun with local transform:

$$T\_local ( Earth ) = ( 1.496 \times 10 \hat{} 11 , 0 , 0 ) meters .$$

Earth's world-space transform is:

$$T\_world ( Earth ) = T\_world ( Sun ) ◦ T\_local ( Earth ) = ( 0 , 0 , 0 ) ◦ ( 1.496 \times 10 \hat{} 11 , 0 , 0 ) = ( 1.496 \times 10 \hat{} 11 , 0 , 0 )$$

At this distance, using 32-bit floating-point representation, the ULP is approximately 1×10\hat{ }4 meters. This means that positions differing by less than 10 kilometers cannot be distinguished.

### Performing the Inversion:

We now invert the parent-child relationship.
Step 1: Reverse the parent-child relationship.
   Earth is now the root. The Sun is now the child of Earth.
Step 2: Compute the inverted local transform.
   The original local transform from Sun to Earth is

$$T\_local ( Earth ) = ( 1.496 \times 10 \hat{} 11 , 0 , 0 ) .$$

The inverted local transform from Earth to Sun is:

$$\begin{matrix}T\_local \_inverted ( Sun ) = inverse ( T\_local ( Earth ) ) \\ = inverse ( ( 1.496 \times 10 \hat{} 11 , 0 , 0 ) ) \\ = ( - 1.496 \times 10 \hat{} 11 , 0 , 0 )\end{matrix}$$

### Configuration After Inversion:

The scene inversion is now complete.
Earth is now the root node with world-space position:

$$T\_world ( Earth ) = ( 0 , 0 , 0 ) .$$

The Sun is now a child of Earth with local transform:

$$T\_local \_inverted ( Sun ) = ( - 1.496 \times 10 \hat{} 11 , 0 , 0 ) .$$

Sun's world-space position is:

$$\begin{matrix}T\_world ( Sun ) = T\_world ( Earth ) ◦ T\_local \_inverted ( Sun ) \\ = ( 0 , 0 , 0 ) ◦ ( - 1.496 \times 10 \hat{} 11 , 0 , 0 ) \\ = ( - 1.496 \times 10 \hat{} 11 , 0 , 0 )\end{matrix}$$

### Verification:

The relative position between Earth and Sun is preserved:
Before inversion: Earth was at (+1.496×10\hat{ }11, 0, 0) relative to the Sun at (0, 0, 0).
After inversion: Sun is at (−1.496×10\hat{ }11, 0, 0) relative to Earth at (0, 0, 0).

The vector from Sun to Earth is (+1.496×10\hat{ }11, 0, 0) in both cases.

### Precision Benefit:

Suppose there is a player character on Earth's surface at a position 1,000 meters from Earth's center along the x-axis.

### Before Inversion (Earth as Child of Sun):

Player's local transform from Earth is T_local (Player)=(1× 10\hat{ }3, 0, 0)
Player's world-space position:

$$\begin{matrix}T\_world ( Player ) = T\_world ( Earth ) ◦ T\_local ( Player ) \\ = ( 1.496 \times 10 \hat{} 11 , 0 , 0 ) ◦ ( 1 \times 10 \hat{} 3 , 0 , 0 ) \\ = ( 1.49600001 \times 10 \hat{} 11 , 0 , 0 )\end{matrix}$$

At this distance, the ULP is approximately 10,000 meters.

If we try to represent a second object at a position 1,001 meters from Earth's center along the x-axis:

$$\begin{matrix}T\_world ( Object 2 ) = T\_world ( Earth ) ◦ T\_local ( Object 2 ) \\ = ( 1.496 \times 10 \hat{} 11 , 0 , 0 ) ◦ ( 1.001 \times 10 \hat{} 3 , 0 , 0 ) \\ = ( 1.49600001001 \times 10 \hat{} 11 , 0 , 0 )\end{matrix}$$

In 32-bit floating-point, both (1.49600001×10\hat{ }11, 0, 0) and (1.49600001001×10\hat{ }11, 0, 0) will round to the same representable value because the difference (1 meter) is far smaller than the ULP (10,000 meters).

Second object at (+1001, 0, 0) from Earth:

$$\begin{matrix}T\_world ( Object 2 ) = T\_world ( Earth ) ◦ T\_local ( Object 2 ) \\ = ( 0 , 0 , 0 ) ◦ ( 1.001 \times 10 \hat{} 3 , 0 , 0 ) \\ = ( 1.001 \times 10 \hat{} 3 , 0 , 0 )\end{matrix}$$

### After Inversion (Earth as Root):

The scene inversion is now complete.
Earth is now at (0, 0, 0).
Player's local offset from Earth: (1×10\hat{ }3, 0, 0)
Player's world-space position:

$$\begin{matrix}T\_world ( Player ) = T\_world ( Earth ) ◦ T\_local ( Player ) \\ = ( 0 , 0 , 0 ) ◦ ( 1 \times 10 \hat{} 3 , 0 , 0 ) \\ = ( 1 \times 10 \hat{} 3 , 0 , 0 )\end{matrix}$$

At this distance, the ULP is approximately 0.0001 meters (0.1 millimeters).

Now (1×10\hat{ }3, 0, 0) and (1.001×10\hat{ }3, 0, 0) are easily distinguishable in 32-bit floating-point because the difference (1 meter) is much larger than the ULP (0.0001 meters).

### Precision Improvement:

The precision improvement can be quantified as the ratio of ULPs:

$$Improvement = ULP before / ULP after = 10 , 000 meters / 0.0001 meters = 100 , 000 , 000 ( over 100 million times better precision )$$

### Summary:

By inverting the scene graph to make Earth the root instead of the Sun, we transformed the player's world-space coordinates from approximately 1.496×10\hat{ }11 meters (low precision) to approximately 1.0×10\hat{ }3 meters (high precision). This inversion preserves the geometric relationships between all objects while dramatically improving precision for objects near Earth, where it matters most for rendering.

### End of Worked Example I: Two-Node Inversion

### Worked Example II: Tree Inversion

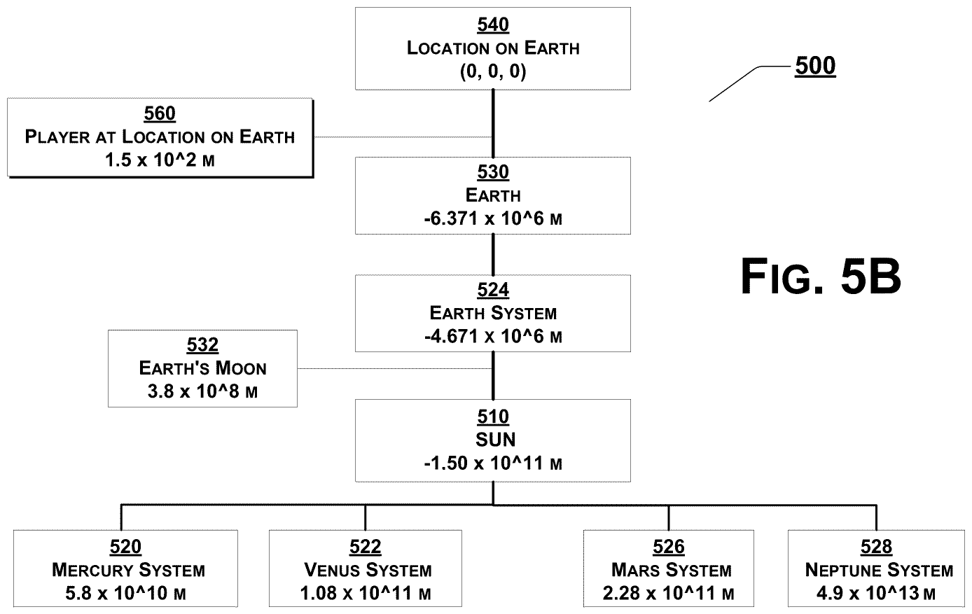

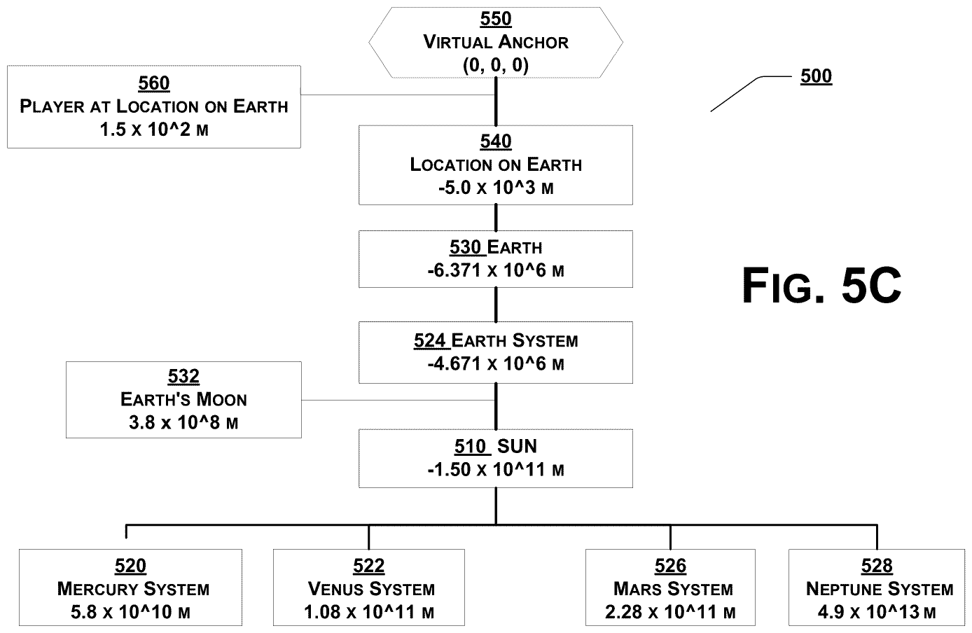

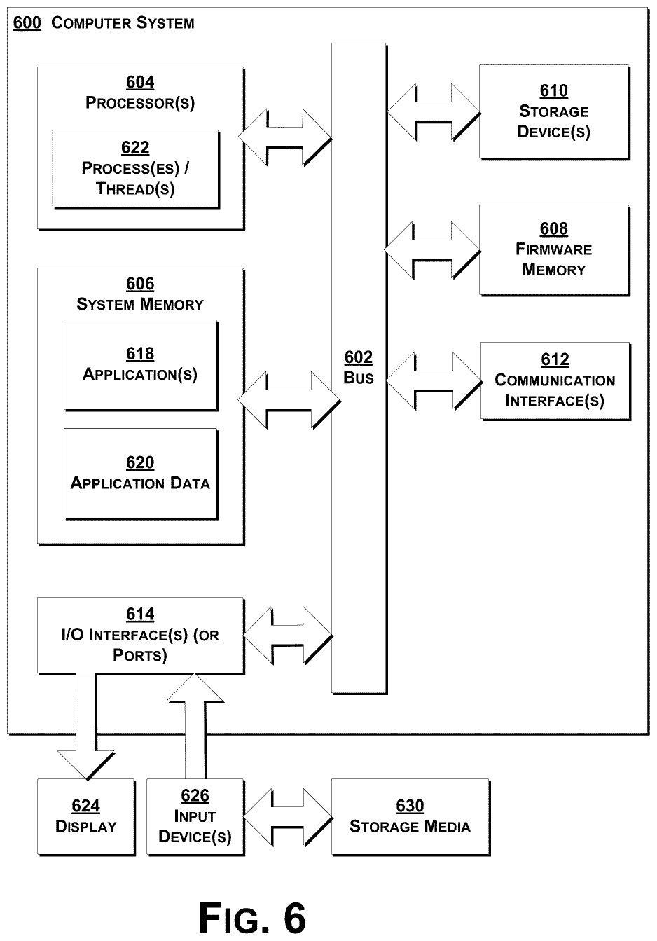

FIGS. 5A and 5B show an example of scene inversion to preserve visible precision in a large-scale three-dimensional floating-point graphics rendering.

As shown in FIG. 5A, in a typical scene, with the Sun 510 as the root node of a scene graph having origin (0, 0, 0), single-precision 32-bit floating-point numbers quickly lose precision. In the drawing, Earth System 524 includes Earth 530 and Earth's Moon 532. A player 560 on the surface of Earth has a world-space position value of 1.49611042150×10\hat{ }11 meters and only a ULP of approximately 10\hat{ }4 meters (10 kilometers). All vertices within a 10-kilometer×10-kilometer×10-kilometer cube would become the same point in a 32-bit calculated scene. This precision is unacceptable. Attempting to create a scene with the Sun at the root of the scene graph results in local objects, such as the player, a camera, and nearby objects, having large world-space, low-precision coordinates. This causes vertices and other coordinate calculations necessary for game play to “snap” together, producing distorted and vanishing meshes.

In this example, the Sun 510 (the root node in FIG. 5A) becomes a distant child of the Location on Earth 540 (the root node in FIG. 5B). In the inverted scene graph, as shown in FIG. 5B, the position of the Sun 510, being affected by loss of precision, will be rounded off to a point up to 10 kilometers from where it would accurately be due to the loss of precision. However, this amounts to only a fraction of a pixel on the display for any object that is 150 million kilometers from the camera. Such a discrepancy is not noticeable.

Parts of the scene graph are inverted so that the local space around the camera viewpoint becomes the scene graph's root node. This root node becomes the origin of scene 500. In the inverted scene graph, as shown in FIG. 5B, the player's scene 500 coordinates have small world-space coordinates that preserve visible precision. The inversion allows local objects (such as the player 560 and nearby objects) to all be computed with small world-space, high-precision coordinates.

The inversion places distant objects, such as the Sun 510 and other planet systems (Mercury System 520, Venus System 522, Mars System 526, and Neptune System 528), into large world-space, low-precision coordinates for the scene. This lowered precision for distant objects is proportional and should be imperceptible in most situations.

### End of Worked Example II

### Example III

FIG. 5C shows an example similar to that in FIG. 5B, with a virtual anchor 550 inserted and used as the target for the inversion.

In this case, a shared virtual anchor 550 (FIG. 5C) is inserted into the scene graph between the player 560 and the Location on Earth 540. This virtual anchor 550, having been placed close to the player's position, is then set as the player's new parent, with the old parent set as the virtual anchor's parent. After scene inversion, the player's local space has small world-space coordinates that preserves visible precision. The position of the virtual anchor may optionally be snapped to agreed intervals such that nearby players can use the same virtual anchor.

### End of Worked Example III

### Floating-Point Representation

Preferred implementations use IEEE-754 (binary32) single-precision floating-point (32-bit) values for vertices and other coordinate calculations. IEEE-754 (binary32) single-precision floating-point (32-bit) values are exactly 32 bits wide. They are partitioned into three fixed fields, laid out from most-significant bit (MSB) to least-significant bit (LSB) as summarized in the following table:

| Field | Bits | Bits | Purpose |
|---|---|---|---|
| Sign | 1 | 31 | Sign of the value (0 → positive, 1 → negative) |
| Exponent | 8 | 30-23 | Biased exponent (Stored as an unsigned integer with bias = 127) |
| Fraction | 23 | 22-0 | Fractional significand bits (mantissa/significand field). For |
| | | | normal numbers, there is an implicit leading 1 (the “hidden |
| | | | bit”), giving 24 bits of precision (which yields approximately |
| | | | 7-8 decimal digits of precision). |
| Total | 32 | | IEEE-754 binary32 |

Alternate implementations may use IEEE-754 (binary64) double-precision floating-point (64-bit) values for vertices and other coordinate calculations. IEEE-754 (binary64) double-precision floating-point (64-bit) values are exactly 64 bits wide. They are partitioned into three fixed fields, laid out from most-significant bit (MSB) to least-significant bit (LSB) as summarized in the following table:

| Field | Bits | Bits | Purpose |
|---|---|---|---|
| Sign | 1 | 63 | Sign of the value (0 → positive, 1 → negative) |
| Exponent | 11 | 62-52 | Biased exponent (Stored as an unsigned integer with |
| | | | bias = 1023) |
| Fraction | 52 | 51-0 | Fractional significand bits (mantissa/significand field). For |
| | | | normal numbers, there is an implicit leading 1 (the “hidden |
| | | | bit”), giving 53 bits of precision (which yields approximately |
| | | | 15-17 decimal digits of precision). |
| Total | 64 | | IEEE-754 binary64 |

Although IEEE-754 binary32 is presently preferred, any floating-point format, encoding, or representation may be used, including IEEE-compliant and non-IEEE floating-point representations.

### Example Clauses

Below, further numbered embodiments of the invention will be presented.

Example Clause A: A computer-implemented method may include: maintaining, in memory of a computing device, a scene graph may include a plurality of nodes organized in a hierarchical tree data structure, where the scene graph has a root node (R) at a world origin, where each particular node, other than the root node (R), has a singular parent node and zero or more child nodes, where each particular node has a local transform expressing a configuration of position, rotation, scale, or shear in accordance with a transformation rule of the particular node relative to its parent node, and where transform values of nodes in the scene graph are represented using floating-point values; and selecting a target node (N) from the plurality of nodes, where the target node (N) is a descendant of the root node (R) in the scene graph; identifying a path from the target node (N) to the root node (R) through the scene graph, the path may include the target node (N), each successive ancestor of the target node (N), where the path terminates at the root node (R); performing a scene inversion along the path to form an inverted path, where, after the scene inversion, the target node (N) becomes the root node such that inverted local transforms of nodes along the inverted path are expressed relative to their respective inverted parent, formerly a child, and where a relative physical arrangement of nodes in three-dimensional space is preserved; and rendering one or more objects in the scene graph using the inverted path.

Example Clause B: The method of Example Clause A, further may include inserting a virtual anchor node into the scene graph prior to performing the scene inversion, where the virtual anchor node is inserted at a chosen position in the scene graph, where one or more nodes in the scene graph are reparented as children of the virtual anchor node, and where the virtual anchor node is selected as the target node (N).

Example Clause C: The method of Example Clause A or Example Clause B, where the virtual anchor node does not correspond to a visible or interactive object in the scene graph.

Example Clause D: The method of any one of Example Clauses A-C, where the virtual anchor node is positioned at or near a camera viewpoint or a player position in the scene graph.

Example Clause E: The method of any one of Example Clauses A-D, where the virtual anchor node is removed from the scene graph when the virtual anchor node is no longer needed.

Example Clause F: The method of any one of Example Clauses A-E, where the position of the virtual anchor node in the scene graph is snapped to a predetermined interval such that a plurality of nodes located near one another in the scene graph share the virtual anchor node as a common parent node in the scene graph.

Example Clause G: The method of any one of Example Clauses A-F, further may include: updating the position of the virtual anchor node in the scene graph as a camera viewpoint or a player position moves through the scene graph and re-performing the scene inversion after updating the position of the virtual anchor node.

Example Clause H: The method of any one of Example Clauses A-G, where the scene inversion is performed starting from the root node (R).

Example Clause I: The method of any one of Example Clauses A-H, where, after the scene inversion, at least one descendant node of the target node is represented by a world-space coordinate having a smaller magnitude than before the scene inversion.

Example Clause J: The method of any one of Example Clauses A-I, where the world-space coordinate corresponds to a smaller unit in the last place for that coordinate than before the scene inversion.

Example Clause K: The method of any one of Example Clauses A-J, where the floating-point values may include single-precision floating-point values.

Example Clause L: The method of any one of Example Clauses A-K, where the floating-point values may include double-precision floating-point values.

Example Clause M: The method of any one of Example Clauses A-L, where vertices and coordinate calculations used for rendering are represented using floating-point values.

Example Clause N: A computer program product may include one or more programs configured to be executed by one or more processors of a computer system, the one or more programs including instructions for performing the method of any one of Example Clauses A-M.

Example Clause O: A device may include one or more processors; and memory storing one or more programs configured to be executed by the one or more processors, the one or more programs including instructions for performing the method of any one of Example Clauses A-M.

Example Clause P: A non-transitory computer-readable storage medium storing one or more programs configured to be executed by one or more processors of a computer system, the one or more programs including instructions for performing the method of any one of Example Clauses A-M.

Example Clause Q: A computer system may include one or more processors and memory storing one or more programs configured to be executed by the one or more processors, the one or more programs including instructions for performing the method of any one of Example Clauses A-M.

### Computing

FIG. 6 illustrates an example computer system 600 that may be used to perform the methods described herein. Computer system 600 includes one or more processors 604 and a memory 606 coupled by an interconnect 602. The memory 606 stores instructions that, when executed by the processor(s) 604, cause the computer system 600 to perform the methods described herein. In some implementations, the processor(s) 604 include a CPU, a GPU, or both.

The computer system may also include firmware (or read-only) memory 608, one or more storage devices 610, one or more communications interfaces 612, and one or more input/output (I/O) interfaces 614 communicatively coupled to the interconnect 602. The computer system 600 may also include devices such as display(s) 624, input device(s) 626, and storage media 630.

The memory 606 is configured to store application(s) 618 and associated data 620. When executed by the processor(s) 604, the application(s) 618 cause the creation of one or more processes and/or threads 622 that implement the functionality described herein.

Embodiments may also be implemented as a non-transitory computer-readable storage medium storing instructions that, when executed by one or more processors, cause a computer system to perform the methods described herein.

Where a process is described herein, those of ordinary skill in the art will appreciate that the process may operate without any user intervention. In another embodiment, the process includes some human intervention (e.g., a step is performed by or with the assistance of a human).

### Notes on Terminology

As used herein, including in the claims, the phrase “at least some” means “one or more” and includes the case of only one. Thus, e.g., the phrase “at least some ABCs” means “one or more ABCs” and includes the case of only one ABC.

As used herein, references to “one or more [entities]” may also be expressed as “entity(s),” with the letter “s” in parentheses, and such usage is intended to encompass both the singular and plural forms. (E.g., “one or more PQRs” may be expressed as “PQR(s).”)

As used herein, including in the claims, the term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used herein, including in the claims, the phrase “using” means “using at least” and is not exclusive. Thus, e.g., the phrase “using X” means “using at least X.” Unless expressly stated by the use of the word “only,” the phrase “using X” does not mean “using only X.”

In general, as used herein, including in the claims, unless the word “only” is specifically used in a phrase, it should not be read into that phrase. Where only one item is intended, the phrase “only one” or similar language is used.

As used herein, including in the claims, the terms “multiple” and “plurality” mean “two or more” and include the case of “two.” Thus, e.g., the phrase “multiple ABCs” means “two or more ABCs” and includes “two ABCs.” Similarly, e.g., the phrase “multiple PQRs” means “two or more PQRs” and includes “two PQRs.”

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components unless expressly so stated.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be used to implement the systems and/or methods as described herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. Many of these features may be combined in ways not explicitly recited in the claims and/or disclosed in the specification.

Although each dependent claim listed below may directly depend on only one claim, the disclosure of various implementations includes each dependent claim in combination with every other claim in the claim set.

No element, act, or instruction used herein should be construed as critical or essential unless explicitly described as such.

As used herein, the term “or” is intended to be inclusive when used in a series and may be used interchangeably with “and/or,” unless explicitly stated otherwise (e.g., if used in combination with “either” or “only one of”).

As used herein, the terms “has,” “have,” “having,” or the like are intended to be open-ended terms.

It will be appreciated that variations to the embodiments of the invention can be made while still falling within the scope of the invention. Alternative features serving the same, equivalent, or similar purpose can replace features disclosed in the specification, unless otherwise stated. Thus, unless stated otherwise, each feature disclosed represents one example of a generic series of equivalent or similar features.

The present invention also covers the exact terms, features, values, and ranges, etc., in case these terms, features, values, and ranges, etc. are used in conjunction with terms such as about, around, generally, substantially, essentially, at least, etc. (i.e., “about 3” shall also cover exactly 3 or “substantially constant” shall also cover exactly constant).

Use of exemplary language, such as “for instance,” “such as,” “for example” (“e.g.,”), and the like, is merely intended to illustrate the invention better and does not indicate a limitation on the scope of the invention unless specifically so claimed.

Any acts described in the specification may be performed in any order or simultaneously unless the context clearly indicates otherwise.

All the features and/or acts disclosed herein can be combined in any combination, except for combinations where at least some of the features and/or acts are mutually exclusive. Preferred features of the invention are applicable to all aspects of the invention and may be used in any combination.

It should be appreciated that the words “first” and “second” in the description and claims are used to distinguish or identify and not to show a serial or numerical limitation. Similarly, letter or numerical labels (such as “(a),” “(b),” and the like) are used to help distinguish and/or identify, and not to show any serial or numerical limitation or ordering.

Unless specifically shown and stated, no ordering is implied by any labeled boxes in flow diagrams. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiment but, on the contrary, is intended to cover various modifications and equivalent arrangements included within the spirit and scope of the appended claims.

Although certain presently preferred embodiments of the invention have been described herein, it will be apparent to those skilled in the art to which the invention pertains that variations and modifications of the described embodiments may be made without departing from the spirit and scope of the invention.

I claim:

1. A computer-implemented method comprising:
maintaining, in memory of a computing device, a scene graph comprising a plurality of nodes organized in a hierarchical tree data structure, wherein the scene graph has a root node (R) at a world origin, wherein each particular node, other than the root node (R), has a singular parent node and zero or more child nodes, wherein each particular node has a local transform expressing a configuration of position, rotation, scale, or shear in accordance with a transformation rule of the particular node relative to its parent node, and wherein transform values of nodes in the scene graph are represented using floating-point values; and
selecting a target node (N) from the plurality of nodes, wherein the target node (N) is a descendant of the root node (R) in the scene graph;
identifying a path from the target node (N) to the root node (R) through the scene graph, the path comprising the target node (N), each successive ancestor of the target node (N), wherein the path terminates at the root node (R);
performing a scene inversion along the path to form an inverted path, wherein, after the scene inversion, the target node (N) becomes the root node such that inverted local transforms of nodes along the inverted path are expressed relative to their respective inverted parent, formerly a child, and wherein a relative physical arrangement of nodes in three-dimensional space is preserved; and
rendering one or more objects in the scene graph using the inverted path.

2. The method of claim 1, further comprising inserting a virtual anchor node into the scene graph prior to performing the scene inversion, wherein the virtual anchor node is inserted at a chosen position in the scene graph, wherein one or more nodes in the scene graph are reparented as children of the virtual anchor node, and wherein the virtual anchor node is selected as the target node (N).

3. The method of claim 2, wherein the virtual anchor node does not correspond to a visible or interactive object in the scene graph.

4. The method of claim 2, wherein the virtual anchor node is positioned at or near a camera viewpoint or a player position in the scene graph.

5. The method of claim 2, wherein the virtual anchor node is removed from the scene graph when the virtual anchor node is no longer needed.

6. The method of claim 2, wherein the position of the virtual anchor node in the scene graph is snapped to a predetermined interval such that a plurality of nodes located near one another in the scene graph share the virtual anchor node as a common parent node in the scene graph.

7. The method of claim 2, further comprising:
updating the position of the virtual anchor node in the scene graph as a camera viewpoint or a player position moves through the scene graph and re-performing the scene inversion after updating the position of the virtual anchor node.

8. The method of claim 1, wherein the scene inversion is performed starting from the root node (R).

9. The method of claim 1, wherein, after the scene inversion, at least one descendant node of the target node is represented by a world-space coordinate having a smaller magnitude than before the scene inversion.

10. The method of claim 9, wherein the world-space coordinate corresponds to a smaller unit in the last place for that coordinate than before the scene inversion.

11. The method of claim 1, wherein the floating-point values comprise single-precision floating-point values.

12. The method of claim 1, wherein the floating-point values comprise double-precision floating-point values.

13. The method of claim 1, wherein vertices and coordinate calculations used for rendering are represented using floating-point values.

14. A computer program product, comprising one or more programs configured to be executed by one or more processors of a computer system, the one or more programs including instructions for performing the method of claim 1.

15. A device comprising one or more processors; and memory storing one or more programs configured to be executed by the one or more processors, the one or more programs including instructions for performing the method of claim 1.

16. A non-transitory computer-readable storage medium storing one or more programs configured to be executed by one or more processors of a computer system, the one or more programs including instructions for performing the method of claim 1.

17. A computer system comprising: one or more processors; and memory storing one or more programs configured to be executed by the one or more processors, the one or more programs including instructions for performing the method of claim 1.
